(19) United States
(12) Patent Application Publication
(10) Pub. No.: US 2021/0185940 A1
(43) Pub. Date: Jun. 24, 2021

(54) PORTABLE HOTHOUSE

(71) Applicant: Jontae El'Breon Harrington, Virginia Beach, VA (US)

(72) Inventor: Jontae El'Breon Harrington, Virginia Beach, VA (US)

(21) Appl. No.: 17/247,645

(22) Filed: Dec. 18, 2020

Related U.S. Application Data
(60) Provisional application No. 62/949,908, filed on Dec. 18, 2019.

(51) Int. Cl. A01G 9/16; A01G 22/00; A01G 9/24

(52) U.S. Cl. CPC A01G 9/16; A01G 9/24; A01G 22/00

(57) ABSTRACT

A temperature-controlled portable hothouse having an arrangement of heat source and transparent framed walls that enables a standalone hothouse that can be easily moved to different location to meet the demands of the user wanting to grow an outside plant in a climate that would typically not support such plant growth.

### CROSS-REFERENCE TO RELATED APPLICATION

This application claims the benefit of priority of U.S. provisional application No. 62/949,908 filed 18 Dec. 2019, the contents of which are herein incorporated by reference.

### BACKGROUND OF THE INVENTION

The present invention relates to horticulture and, more particularly, a temperature-controlled micro greenhouse and a portable hothouse.

Plant life is very diverse around the world as a function of the local climate. Though vegetation from climates that are warm year-round are generally acknowledged as the most biologically diverse compared to plant life from other latitudes. These tropical plants offer, many would say, a beauty and exotic visual appearance not afforded by plants of other regions. However, tropic plants do not have the ability to grow in cold climates, thus preventing people from these non-tropical regions from enjoying such plant life, except when the travel to a public exhibit (in a museum or horticultural conservatory) or if they are fortunate enough to own a greenhouse or hothouse, which can be expensive to procure and maintain.

As can be seen, there is a need for a temperature-controlled micro greenhouse and/or portable hothouse. The present invention embodies a portable hothouse enabling greenhouse-effect cocoon dimensioned and adapted to control the temperature and climate for a plant by way of a rechargeable heater. Thus, users are afforded the opportunity to grow and enjoy tropical plant life in any climate, wherein the hothouse needed for this growth is portable.

### SUMMARY OF THE INVENTION

In one aspect of the present invention, a portable hothouse having the following: transparent walls defining a cocoon compartment having a lower opening communicating to an environment external to the cocoon compartment; and an arcuate base adjacent to and along a periphery of the lower opening, wherein the arcuate base comprises a heat source, whereby the cocoon compartment is dimensioned to house a plant.

In another aspect of the present invention, the portable hothouse further includes spaced apart framing supporting the transparent walls, wherein the cocoon compartment has a conical geometry, wherein the transparent walls comprise an upper wall and a tapered sidewall defining the conical geometry; a heat sensor along an inner surface of the transparent walls, and wherein the arcuate base has a mass adapted to enable the portable hothouse to be freestanding on the lower opening.

In yet another aspect of the present invention, method of growing a tropical plant in a non-tropical climate using a portable hothouse, the method includes the following: moving the portable hothouse from claim 6 from a first place to a second place; and placing the lower opening over an area of ground, wherein a seed of the tropical plant is thereunder.

These and other features, aspects and advantages of the present invention will become better understood with reference to the following drawings, description and claims

### BRIEF DESCRIPTION OF THE DRAWINGS

FIG. 1 is a perspective view of an exemplary embodiment of the present invention; and

FIG. 2 is a perspective view of an exemplary embodiment of the present invention, shown in use.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a temperature-controlled portable hothouse having an arrangement of heat source and transparent framed walls that enables a standalone hothouse that can be easily moved to different location to meet the demands of the user wanting to grow an outside plant in a climate that would typically not support such plant growth.

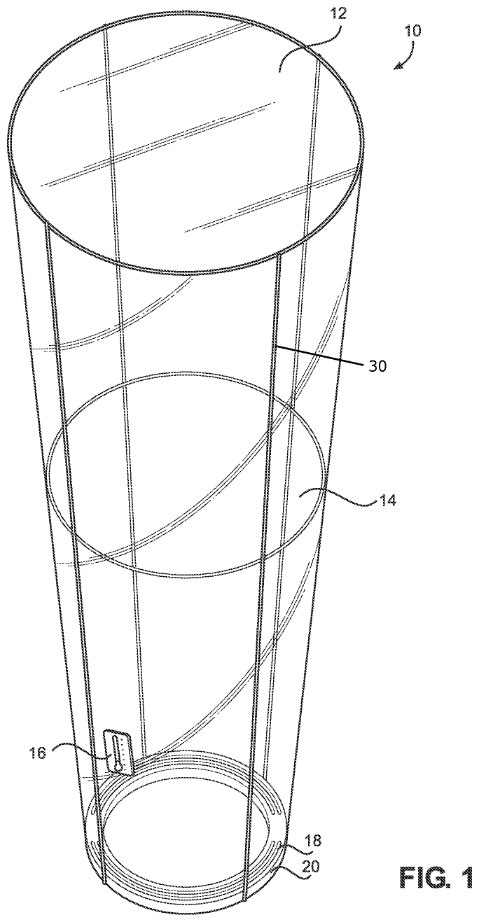

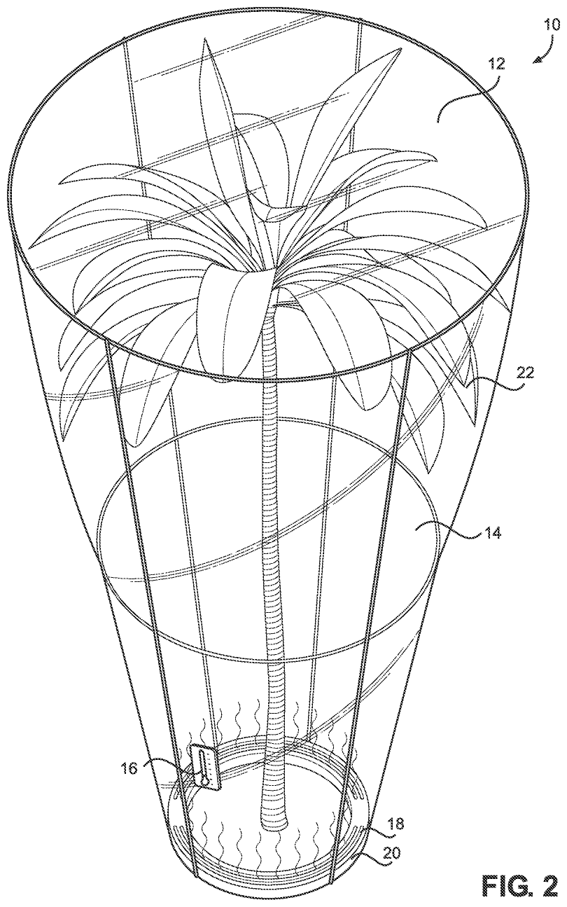

Referring now to FIGS. 1 and 2, the present invention may include temperature-controlled micro greenhouse or portable hothouse 10. The portable hothouse 10 may have conical, spaced-apart framing 30, wherein an upper base and a lower base of the conical framing 30 may be, though not necessarily, circular. Along the upper base of the framing 30 is a transparent roof or upper wall 12. Along the tapering portion of the framing 30 may be a transparent sidewall 14. The transparent upper wall 12 and sidewall 12 may be made of clear polycarbonate plastic or other equivalent material that allows light to pass through yet sufficiently prevents thermal energy from passing therethrough. The polycarbonate plastic may also be conducive for attaches images.

It should also be understood that the shape of the framing 30 may be geometrically cylindrical or differently volumetrically shaped as long as the overall geometry is conducive for circumscribing or ‘cocooning’ one plant 22, portability, and the greenhouse effect. Likewise, the length of the framing can be any size conducive to its purpose, ranging between one foot to 10 feet in length/height.

Along the lines of cocooning, the geometry provides at the tapered end (at least in the embodiment illustrated in the figures—it being understood other geometrical embodiments are contemplated herein) or the lower base provides a lower opening not covered by framing, walling or the like. The lower opening communicates the external environment to the volumetric compartment dimensioned to cocoon the plant 22, whereby a stalk of the plant 22 may extend from the ground through the lower opening and into the compartment, as illustrated in FIG. 2.

Adjacent the lower opening, such as along the periphery of the lower opening, may be a weighted base 20 having a heat source 18, such as a rechargeable heating pump. The weighted base 20 has its own base opening typically concentric with the lower opening, or otherwise, so that said stalk can pass from the ground into the cocoon compartment through the wall/base openings.

Along the transparent sidewall 14 may be a thermal sensor 16, such as a thermometer for indicating the thermal conditions within the cocoon compartment that can be selectively controlled by the heat source 18.

A method of using the present invention may include the following. A user may obtain and move the portable hothouse 10 so that the lower opening receives or will receive a stalk of the plant 22 as it engages the ground the stalk is or will extend from. In other words, in the case where there is a preexisting plant 22, the user would simply cover the plant 22 with the cocoon compartment, as the circular weights give the portable hothouse 10 a tight fit connect the declarable heater 18 at the base, as the transparent walls shield the plant 22 from the external environment.

The thermal sensor 16 allows the user to monitor the temperature inside the present invention and so gauge to what extent they should selectively control the heat source 18. As a result, a user can grow a tropical plant 22 outside in a non-tropical climate without investing in an expensive greenhouse. Furthermore, the present invention is portable (unlike an expensive greenhouse) so that the user can move it around on their property (as opposed to be limited to growing a plant only where the greenhouse is physically fixed to the land) as well as sell or give the present invention for others to carry and move to a location they desire. Additionally, the present invention could be used to control a cold space in a hot climate.

It should be understood, of course, that the foregoing relates to exemplary embodiments of the invention and that modifications may be made without departing from the spirit and scope of the invention as set forth in the following claims.

What is claimed is:

1. A portable hothouse comprising:
transparent walls defining a cocoon compartment having a lower opening communicating to an environment external to the cocoon compartment; and
an arcuate base adjacent to and along a periphery of the lower opening, wherein the arcuate base comprises a heat source, whereby the cocoon compartment is dimensioned to house a plant.

2. The portable hothouse of claim 1, further comprising spaced apart framing supporting the transparent walls.

3. The portable hothouse of claim 2, wherein the cocoon compartment has a conical geometry.

4. The portable hothouse of claim 3, wherein the transparent walls comprise an upper wall and a tapered sidewall defining the conical geometry.

5. The portable hothouse of claim 4, further comprising a heat sensor along an inner surface of the transparent walls.

6. The portable hothouse of claim 5, wherein the arcuate base has a mass adapted to enable the portable hothouse to be freestanding on the lower opening.

7. A method of growing a tropical plant in a non-tropical climate using a portable hothouse, the method comprising:
moving the portable hothouse from claim 6 from a first place to a second place; and
placing the lower opening over an area of ground, wherein a seed of the tropical plant is thereunder.
